(19) United States
(12) Patent Application Publication
(10) Pub. No.: US 2026/0077460 A1
(43) Pub. Date: Mar. 19, 2026

(54) GAS CYLINDER SEPARATION TOOL SET

(71) Applicant: Andrew S Johnson, Pensacola, FL (US)

(72) Inventor: Andrew S Johnson, Pensacola, FL (US)

(21) Appl. No.: 18/884,306

(22) Filed: Sep. 13, 2024

(51) Int. Cl. B25B 27/02; B25B 7/02

(52) U.S. Cl. CPC B25B 27/02; B25B 7/02

(57) ABSTRACT

A two plier set for removing gas cylinders from chairs has each pair of pliers with a jaw pair hinged together and with a circular opening formed when the jaws of the pliers are closed. The opening on one set of pliers is different in size relative to the opening of the other set of pliers. A ring having undulating hills and valleys encircles the opening on each set of pliers. The two sets of pliers are abutted together so that the rings of each mesh with one another, hills of one ring seated within a valley of the other ring and vice versa. Rotating the pliers relative to one another causes the hills of each ring to climb toward the hills of the other ring forcing separation of the pliers from one another and thereby separating the end of the gas cylinder from its securement plate.

### BACKGROUND OF THE INVENTION

### 1. Field of the Invention

The present invention relates to a dual set of cooperating pliers used to remove a gas cylinder from a chair.

### 2. Background of the Prior Art

Chairs, such as office chairs, task chairs, and gaming chairs, often have a pneumatic cylinder, often referred to as a gas cylinder, which cylinder is used for height adjustment of the chair as well as cushioning of the chair while in use. The gas cylinder has an air valve, operated by an easy to reach handle, such that letting air into the cylinder raises the chair and releasing air from the cylinder lowers the chair. The air within the cylinder provides the cushioning effect for the user. Such gas cylinders work incredibly well and allow the user to have a chair that is easily positioned at a desired height and that is quite comfortable to sit in for extended periods of time. The cylinder itself is a relatively inexpensive addition to the chair which often costs several hundred dollars.

While effective, the gas cylinder sometimes fails, causing the chair to fall to its lowest height level and making for a hard, uncushioned sitting surface for the user. As these types of chairs tend to be relatively expensive, it is desirable to replace the failed cylinder with a new cylinder. The end of the cylinder is substantially conical in shape and is press fit into a plate at relatively high pressure. In order to replace the cylinder, the cylinder must be broken free from its press fit engagement with the plate to which the cylinder is attached. As the pressure of attachment is relatively high, simply pulling the end of the cylinder from the plate to which the cylinder is attached is not an option. Often, a hammer is used to break the pressure of the fit to free the cylinder from the plate. As can be imaged, the hammer can cause damage to the chair as well as to the attachment plate for the gas cylinder, possibly requiring the plate's replacement alongside the gas cylinder. The hammer can also damage the gas cylinder itself which is problematic if the chair is being broken down for storage and shipping and otherwise has a functional gas cylinder.

To address this crude method of separating the gas cylinder from the plate to which it is press fit, dedicated devices have been proposed that separate the two without the need for potentially damaging percussive strikes. Such devices, which come in a variety of styles and architectures are either too expensive for the task at hand or are unusually complex in construction so as to be difficult to use and maintain.

What is needed is a device that quickly and easily separates a gas cylinder from the plate or other hub to which the cylinder is attached which does not require striking any components of the overall system and which is relatively simple to use and maintain.

### SUMMARY OF THE INVENTION

The gas cylinder separation tool set of the present invention addresses the aforementioned needs in the art by providing a system that quickly and easily separates a typical gas cylinder used with a variety of chairs from the plate or other hub to which the cylinder is press fit attached. The gas cylinder separation tool set is easy to use without any requirement for specialized skills and performs its task in a rapid efficient manner. The gas cylinder separation tool set does not require percussive strikes to minimize any potential for damage to the various components of the chair. The gas cylinder separation tool set is of relatively simple design and construction, being produced using standard manufacturing, is relatively inexpensive to produce so that the device is economically attractive to potential consumers for this type of device.

The gas cylinder separation tool set of the present invention is comprised of a first pair of pliers that has a pair of first jaws hingedly connected to one another and a first handle extending downwardly from each first jaw. Each first jaw has a semi-circular first cutout such that when the first pair of pliers is in a first closed position, the two first cutouts mate and form a first circular opening. A first pair of undulation plates, which plates are each semi-circular ring members, is attached to a respective one of the first jaws so that when the first pair of pliers is in the first closed position, the two first undulation plates abut at their respective ends and form a first ring that encircles the first opening. The first ring has a series of first hills and first valleys. A second pair of pliers has a second pair of jaws hingedly connected to one another and a second handle extending downwardly from each second jaw. Each second jaw has a semi-circular second cutout so that when the second pair of pliers is in a second closed position, the two second cutouts mate and form a second circular opening. A second pair of undulation plates, which plates are each semi-circular ring members, is attached to a respective one of the second jaws so that when the second pair of pliers is in the second closed position, the two second undulation plates abut at their respective ends and form a second ring that encircles the second opening. The second ring has a series of second hills and second valleys. The first opening has a first diameter and the second opening has a second diameter that is smaller relative to the first diameter. The first ring has a third diameter and the second ring has a fourth diameter that is the same size as the third diameter. Each of the first hills and each of the second hills all have the same amplitude as well as the same period. Each first valley and each second valley have the same period as the period of each first hill and each second hill. The first pair of jaws are attached to one another via a first hinge pin and the second pair of jaws are attached to one another via a second hinge pin.

### BRIEF DESCRIPTION OF THE DRAWINGS

FIG. 1 is an environmental view of the gas cylinder separation tool set of the present invention being used to detach a gas cylinder from a chair.

FIG. 2 is a perspective view of the two sets of pliers of the gas cylinder separation tool set abutting one another.

FIG. 3 is a perspective view of the two sets of pliers of the gas cylinder separation tool set separated from one another.

FIG. 4 is a perspective view of one of the pairs of pliers of the gas cylinder separation tool.

FIG. 5 is a plan view of one of the pairs of pliers of the gas cylinder separation tool set in an open position.

FIG. 6 is a plan view of one of the pairs of pliers of the gas cylinder separation tool set in a closed position.

FIG. 7 is a sectioned view of one of the pairs of pliers of the gas cylinder separation tool set taken along line 7-7 in FIG. 6

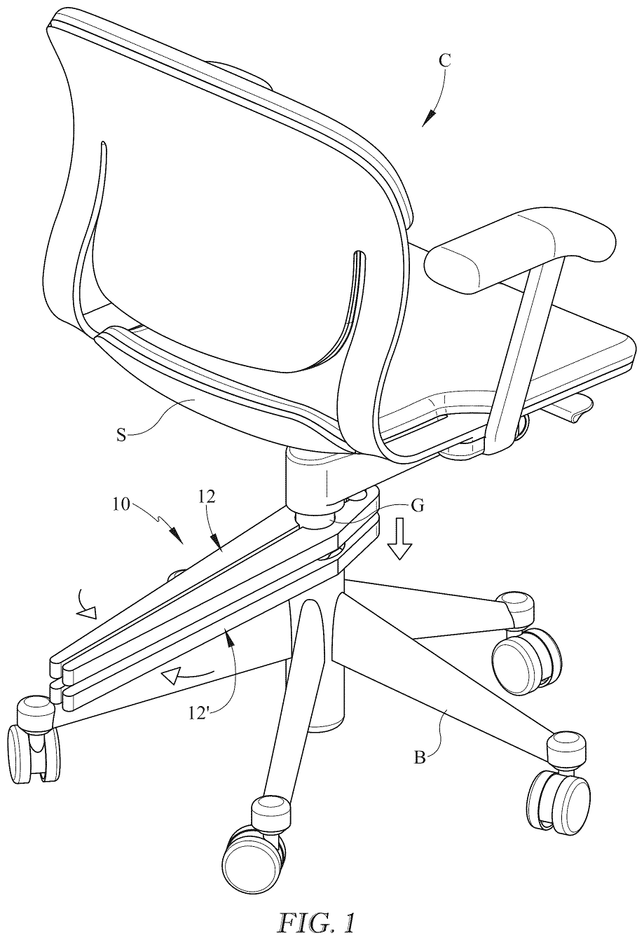

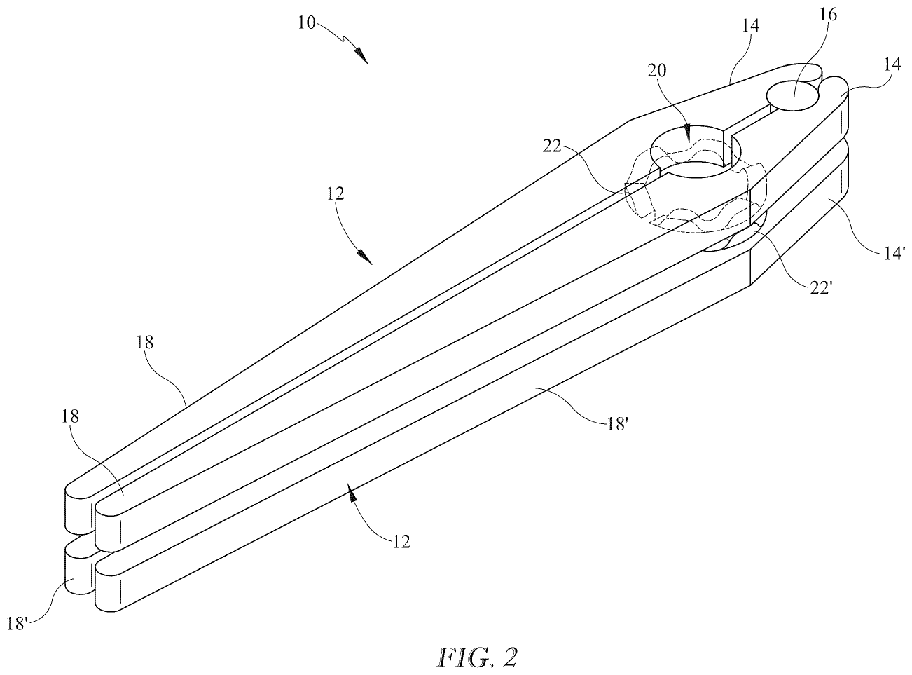

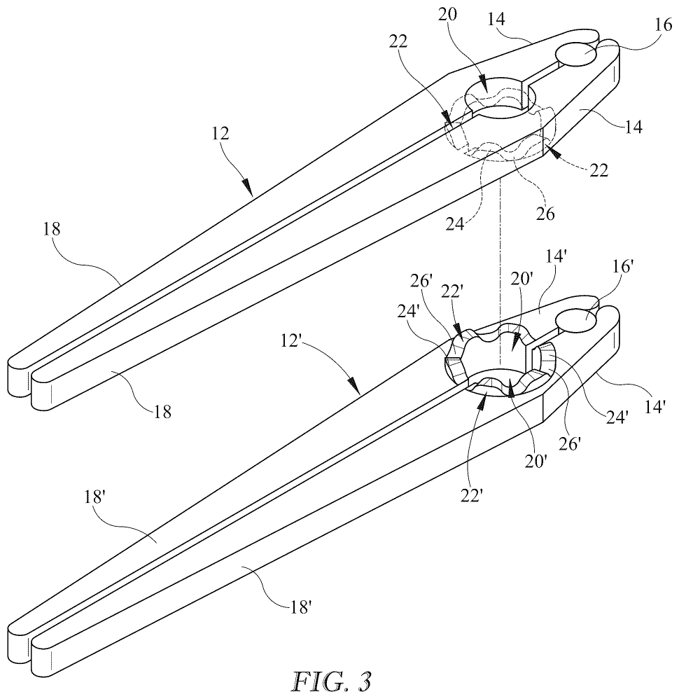

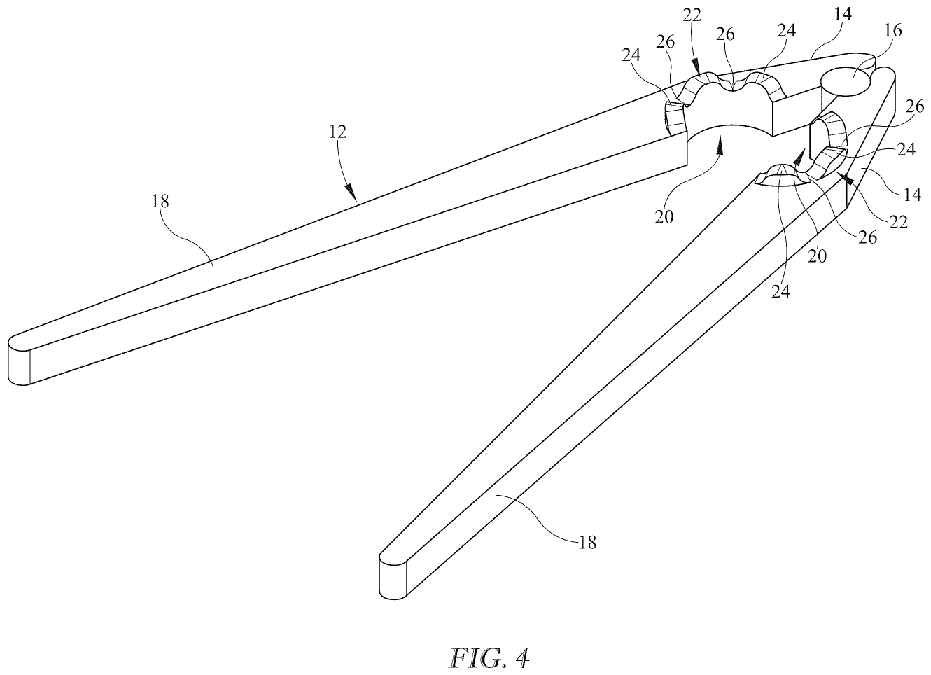

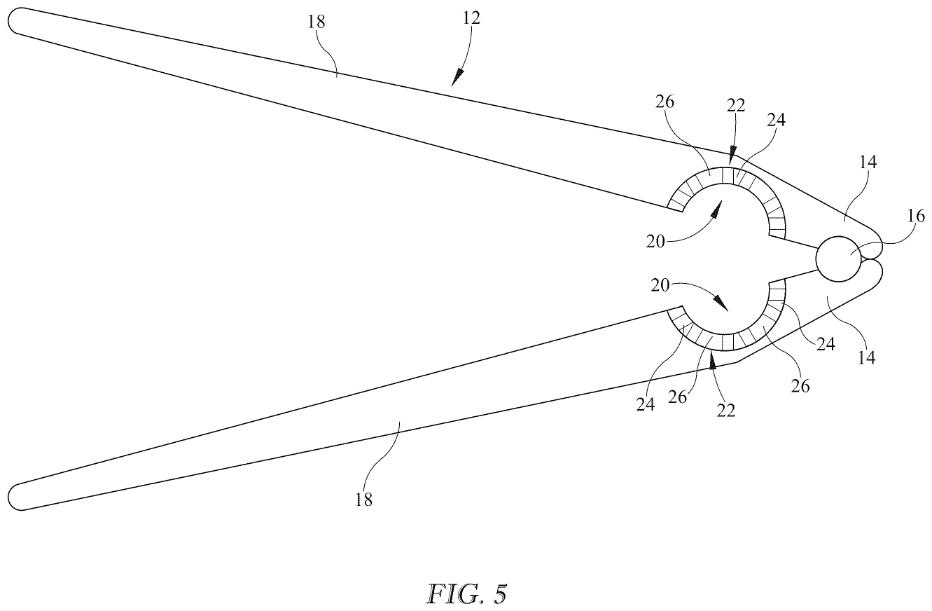

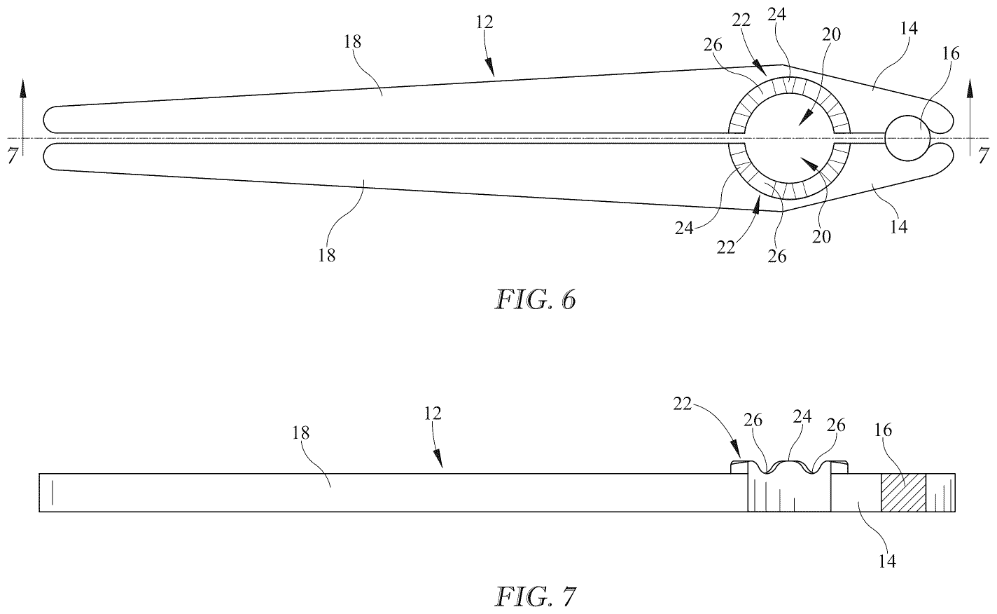

Similar reference numerals refer to similar parts throughout the several views of the drawings.

### DESCRIPTION OF THE PREFERRED EMBODIMENT

Referring now to the drawings, it is seen that the gas cylinder separation tool set of the present invention, generally denoted by reference numeral 10, is comprised of a first pair of pliers 12 and a second pair of pliers 12′, the two pairs of pliers 12 and 12′ being similar with differences between the two described below.

As seen, the first pair of pliers 12 is comprised of a pair of jaws 14 that are hingedly attached to one another in any appropriate fashion such as the illustrated hinge pin 16. A handle 18 extends down from each jaw 14. Each jaw 14 has a semi-circular cutout 20. An undulation plate 22, which is a semi-circular ring member, is attached to one side of each jaw 14, just beyond the periphery of the jaw's cutout 20. The pliers 12 articulate between an open position and a closed position. Whenever the first pliers 12 are in a closed position, the two jaws 14 abut one another. In this closed position, the cutouts 20 of each joint correspond and form a circular opening. Similarly, when the first pliers 12 are in the closed position, the two undulation plates 22 abut at their respective ends and form a full ring that encircles the formed opening created by the two cutouts 20. As seen, the formed ring created by the two undulation plates 22 has a series of hills 24 and valleys 26 such that the height of each hill 24 is identical as are the periods and the periods of each valley 26 is identical to the period of each hill 24. The hills 24 and valleys 26 are generally curved.

As seen, the second pair of pliers 12′ is also comprised of a pair of jaws 14′ that are hingedly attached to one another in any appropriate fashion such as the illustrated hinge pin 16′. A handle 18′ extends down from each jaw 14′. Each jaw 14′ has a semi-circular cutout 20′. An undulation plate 22′, which is a semi-circular ring member, is attached to one side of each jaw 14′, just beyond the periphery of the jaw's cutout 20′. The second pliers 12′ articulate between an open position and a closed position. Whenever the second pliers 12′ are in a closed position, the two jaws 14′ abut one another. In this closed position, the cutouts 20′ of each joint correspond and form a circular opening. Similarly, the two undulation plates 22′ abut at their respective ends and form a full ring that encircles the formed opening created by the two cutouts 20′. As seen, the formed ring created by the two undulation plates 22′ has a series of hills 24′ and valleys 26′ such that the height of each hill 24′ is identical as are the periods and the periods of each valley 26 is identical to the period of each hill 24′. The hills 24′ and valleys 26′ are generally curved.

The two pairs of pliers 12 and 12′ are substantially similar in size and shape, however, the opening formed by the cutouts 20 of the first pair of pliers 12 has a larger diameter relative to the opening formed by the cutouts 20′ of the second pair of pliers 12′. The ring formed by the first undulation plate 22 attached to the first pliers 12 is identical in size to the ring formed by the second undulation plate 22′ attached to the second pliers 12′. In this way, when the ring of the first pair of pliers 12 is mated with the ring of the second pair of pliers 12′, the two rings snugly rest within one another with the hills of one of the rings each seated within a respective one valley of the other ring and vice versa.

In order to use the gas cylinder separation tool set 10 of the present invention, the first pair of pliers 12 is opened and positioned about the main body of a gas cylinder G of a typical chair C and then closed so that the gas cylinder G is encircled by the opening formed by the abutting cutaways 20 of the first pair of pliers 12. In similar fashion, the second pair of pliers 12′ is opened and positioned about the conical end body of the gas cylinder G of the chair C and then closed so that conical end of the gas cylinder G is encircled by the opening formed by the abutting cutaways 20′ of the first pair of pliers 12′. The first pair of pliers 12 is immediately adjacent to the second pair of pliers 12′ so that the ring formed by the undulation pates 22 of the first pair of pliers 12 is meshed with the ring formed by the undulation plates 22′ of the second pair of pliers 12′, hills of each ring seated within the valleys of the other ring. The two pairs of pliers 12 and 12′ are radially offset from one another. A user, holding each pair of pliers 12 and 12′ in their respective closed position, gradually rotates the pliers 12 and 12′ toward one another. During this rotation, the hills of each pair of pliers 12 and 12′ climb up the wall of the valley in which each hill is located until the hills 24 of one of the plier pair 12 is seated atop the hills 24′ of the other plier pair 12′. This causes the pliers 12 and 12′ to be pushed apart from one another which causes the second pair of pliers 12′ to push down on the base B of the chair C thereby breaking press fit engagement of the gas cylinder G with its attachment point on the base B. This causes the base B of the chair C to be separated from the seating portion S of the chair C. The gas cylinder G of chair C is now removed from the seating portion S of the chair C and replaced as necessary.

While the invention has been particularly shown and described with reference to an embodiment thereof, it will be appreciated by those skilled in the art that various changes in form and detail may be made without departing from the spirit and scope of the invention.

I claim:

1. A tool set comprising:
a first pair of pliers having a first pair of jaw hingedly connected to one another and a first handle extending downwardly from each first jaw, each first jaw having a semi-circular first cutout so that when the first pair of pliers is in a first closed position, the two first cutouts mate and form a first circular opening;
a first pair of undulation plates, each first undulation plate attached to a respective one of the first jaws so that when the first pair of pliers is in the first closed position, the two first undulation plates abut and form a first ring that encircles the first opening, the first ring having a series of first hills and first valleys;
a second pair of pliers having a second pair of jaws hingedly connected to one another and a second handle extending downwardly from each second jaw, each second jaw having a semi-circular second cutout so that when the second pair of pliers is in a second closed position, the two second cutouts mate and form a second circular opening; and
a second pair of undulation plates, each second undulation plate attached to a respective one of the second jaws so that when the second pair of pliers is in the second closed position, the two second undulation plates abut and form a second ring that encircles the second opening, the second ring having a series of second hills and second valleys.

2. The tool set as in claim 1 wherein the first opening has a first diameter and the second opening has a second diameter that is smaller relative to the first diameter.

3. The tool set as in claim 2 wherein the first ring has a third diameter and the second ring has a fourth diameter that is the same size as the third diameter.

4. The tool set as in claim 3 wherein each of the first hills and each of the second hills all have the same amplitude.

5. The tool set as in claim 4 wherein each of the first hills and each of the second hills all have the same period.

6. The tool set as in claim 5 wherein each first valley and each second valley have the same period as the period of each first hill and each second hill.

7. The tool set as in claim 1 wherein the first ring has a first diameter and the second ring has a second diameter that is the same size as the first diameter.

8. The tool set as in claim 7 wherein each of the first hills and each of the second hills all have the same amplitude.

9. The tool set as in claim 8 wherein each of the first hills and each of the second hills all have the same period.

10. The tool set as in claim 9 wherein each first valley and each second valley have the same period as the period of each first hill and each second hill.

11. The tool set as in claim 1 wherein the each of the first pair of jaws are attached to one another via a first hinge pin and each of the second pair of jaws are attached to one another via a second hinge pin.

12. The tool set as in claim 11 wherein the first opening is disposed between the first hinge pin and the first handles and the second opening is disposed between the second hinge pin and the second handles.

13. The tool set as in claim 1 wherein the first opening is disposed between the hinged attachment point of the first pair of jaws and the first handles and the second opening is disposed between the hinged attachment point of the second jaws and the second handles.
